(19) United States
(12) Patent Application Publication
(10) Pub. No.: US 2012/0082431 A1
(43) Pub. Date: Apr. 5, 2012

(54) METHOD, APPARATUS AND COMPUTER PROGRAM PRODUCT FOR SUMMARIZING MULTIMEDIA CONTENT

(75) Inventors: Biswadeep SENGUPTA, Bangalore (IN); Sidharth M. PATIL, Bangalore (IN); Pranav MISHRA, Bangalore (IN)

(73) Assignee: NOKIA CORPORATION, Espoo (FI)

(21) Appl. No.: 13/250,725

(22) Filed: Sep. 30, 2011

(30) Foreign Application Priority Data
Sep. 30, 2010 (IN) 2906/CHE/2010

(51) Int. Cl. H04N 9/80

(52) U.S. Cl. 386/241; 386/E05.003

(57) ABSTRACT

In accordance with an example embodiment a method and apparatus is provided. The method comprises calculating an attribute for a set of encoded frames of a multimedia file. A frame attribute of at least one encoded frame of the set of encoded frames is compared with a threshold value, which is based on the attribute for the set of encoded frames. An encoded frame of the set of encoded frames is selected as a primary summary file of the multimedia file based on the comparison of the frame attribute of the at least one encoded frame with the threshold value.

### RELATED APPLICATIONS

This application claims priority benefit from Indian Patent Application No. 29061CHE/2010, filed on Sep. 30, 2010, which is herein incorporated in its entirety by reference.

### TECHNICAL FIELD

Various implementations relate generally to method, apparatus, and computer program product for summarizing multimedia content.

### BACKGROUND

The rapid advancement in technology related to capture and storage of multimedia content has resulted in an exponential increase in the creation of the multimedia content. Devices like mobile phones and personal digital assistants (PDA) are now being increasingly configured with video capture tools, such as a camera, thereby facilitating easy capture of the multimedia content. The captured multimedia content may be stored locally in an in-built memory of the devices or may be stored in a removable memory device, for example a memory card. Such a mechanism facilitates handy storage of the captured multimedia content.

Though the enhancement in technology related to storage of the multimedia content has vastly increased a storage capacity for storing of the multimedia content, the technology for enabling easy retrieval of the stored multimedia content is still evolving. For example, it may be desirable to provide a preview or a summarized version of a multimedia content, for example a video file, to a user for enabling the user to select or reject viewing of the multimedia content without having to view the entire multimedia content. This may be especially desirable when the user has to sift through massive amounts of the multimedia content to select a particular type of multimedia content for viewing. Moreover, for the multimedia content of lengthy time duration, a user may also desire to view the preview in a manner wherein the user may be able to navigate to a particular scene within the multimedia content, thereby enhancing a see-seek operation for the user.

### SUMMARY OF SOME EMBODIMENTS

Various aspects of examples of the invention are set out in the claims.

In a first aspect, there is provided a method comprising: calculating an attribute for a set of encoded frames of a multimedia file; comparing a frame attribute of at least one encoded frame of the set of encoded frames with a threshold value, wherein the threshold value is based on the attribute for the set of encoded frames; and selecting an encoded frame of the set of encoded frames as a primary summary file of the multimedia file based on the comparison of the frame attribute of the at least one encoded frame with the threshold value.

In a second aspect, there is provided an apparatus comprising: at least one processor; and at least one memory comprising computer program code, the at least one memory and the computer program code configured to, with the at least one processor, cause the apparatus at least to: calculate an attribute for a set of encoded frames of a multimedia file; compare a frame attribute of at least one encoded frame of the set of encoded frames with a threshold value, wherein the threshold value is based on the attribute for the set of encoded frames; and select an encoded frame of the set of encoded frames as a primary summary file of the multimedia file based on the comparison of the frame attribute of the at least one encoded frame with the threshold value.

In a third aspect, there is provided a computer program product comprising at least one computer-readable storage medium, the computer-readable storage medium comprising a set of instructions, which, when executed by one or more processors, cause an apparatus to at least: calculate an attribute for a set of encoded frames of a multimedia file; compare a frame attribute of at least one encoded frame of the set of encoded frames with a threshold value, wherein the threshold value is based on the attribute for the set of encoded frames; and select an encoded frame of the set of encoded frames as a primary summary file of the multimedia file based on the comparison of the frame attribute of the at least one encoded frame with the threshold value.

In a fourth aspect, there is provided an apparatus comprising: means for calculating an attribute for a set of encoded frames of a multimedia file; means for comparing a frame attribute of at least one encoded frame of the set of encoded frames with a threshold value, wherein the threshold value is based on the attribute for the set of encoded frames; and means for selecting an encoded frame of the set of encoded frames as a primary summary file of the multimedia file based on the comparison of the frame attribute of the at least one encoded frame with the threshold value.

In a fifth aspect, there is provided a computer program comprising program instructions which when executed by an apparatus, cause the apparatus to: calculate an attribute for a set of encoded frames of a multimedia file; compare a frame attribute of at least one encoded frame of the set of encoded frames with a threshold value, wherein the threshold value is based on the attribute for the set of encoded frames; and select an encoded frame of the set of encoded frames as a primary summary file of the multimedia file based on the comparison of the frame attribute of the at least one encoded frame with the threshold value.

### BRIEF DESCRIPTION OF THE FIGURES

For a more complete understanding of example embodiments of the present invention, reference is now made to the following descriptions taken in connection with the accompanying drawings in which:

FIG. 1 illustrates a device in accordance with an example embodiment;

FIG. 2 illustrates an apparatus for summarizing multimedia content in accordance with an example embodiment;

FIG. 3 illustrates example encoded frames of a multimedia file in accordance with an example embodiment;

FIG. 4 illustrates an example of a display depicting plurality of primary summary files in accordance with an example embodiment;

FIG. 5 is a flowchart depicting an example method for summarizing of multimedia content in accordance with an example embodiment; and

FIG. 6 is a flowchart depicting an example method for summarizing of multimedia content in accordance with another example embodiment.

### DETAILED DESCRIPTION

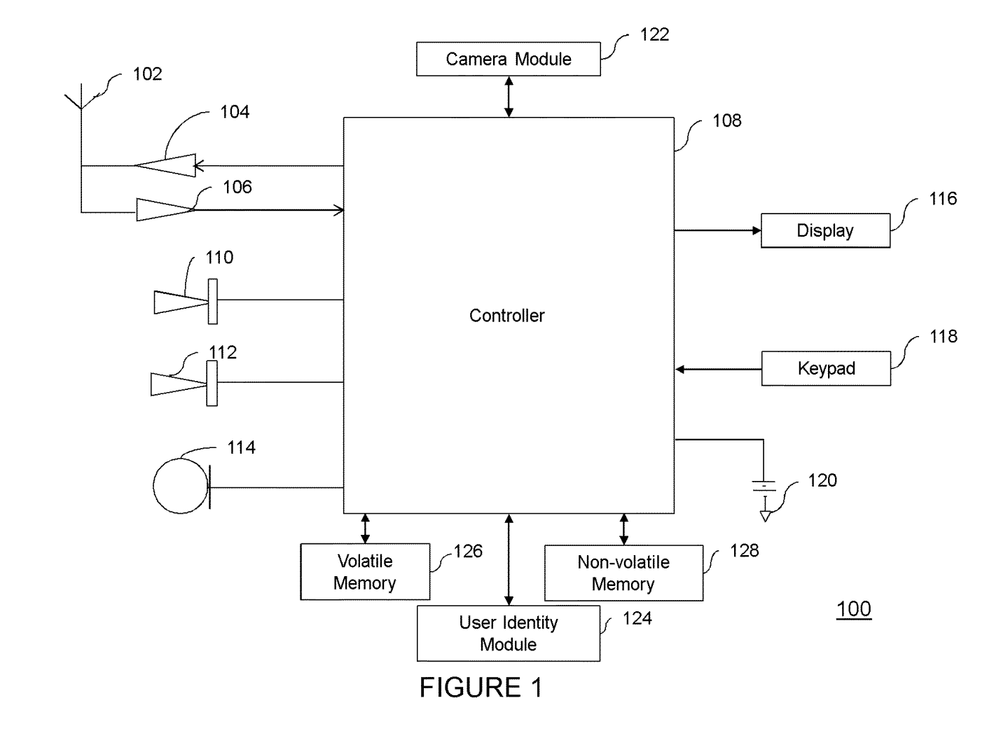

Example embodiments and their potential effects are understood by referring to FIGS. 1 through 6 of the drawings.

FIG. 1 illustrates a device 100 in accordance with an example embodiment. It should be understood, however, that the device 100 as illustrated and hereinafter described is merely illustrative of one type of device that may benefit from various embodiments, therefore, should not be taken to limit the scope of the embodiments. As such, it should be appreciated that at least some of the components described below in connection with the device 100 may be optional and thus in an example embodiment may include more, less or different components than those described in connection with the example embodiment of FIG. 1. The device 100 could be any of a number of types of mobile electronic devices, for example, portable digital assistants (PDAs), pagers, mobile televisions, gaming devices, cellular phones, all types of computers (for example, laptops, mobile computers or desktops), cameras, audio/video players, radios, global positioning system (GPS) devices, media players, mobile digital assistants, or any combination of the aforementioned, and other types of communications devices.

The device 100 may include an antenna 102 (or multiple antennas) in operable communication with a transmitter 104 and a receiver 106. The device 100 may further include an apparatus, such as a controller 108 or other processing device that provides signals to and receives signals from the transmitter 104 and receiver 106, respectively. The signals may include signaling information in accordance with the air interface standard of the applicable cellular system, and/or may also include data corresponding to user speech, received data and/or user generated data. In this regard, the device 100 may be capable of operating with one or more air interface standards, communication protocols, modulation types, and access types. By way of illustration, the device 100 may be capable of operating in accordance with any of a number of first, second, third and/or fourth-generation communication protocols or the like. For example, the device 100 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA1000, wideband CDMA (WCDMA) and time division-synchronous CDMA (TD-SCDMA), with 3.9G wireless communication protocol such as evolved-universal terrestrial radio access network (E-UTRAN), with fourth-generation (4G) wireless communication protocols, or the like. As an alternative (or additionally), the device 100 may be capable of operating in accordance with non-cellular communication mechanisms. For example, computer networks such as the Internet, local area network, wide area networks, and the like; short range wireless communication networks such as include Bluetooth® networks, Zigbee® networks, Institute of Electric and Electronic Engineers (IEEE) 802.11x networks, and the like; wireline telecommunication networks such as public switched telephone network (PSTN).

The controller 108 may include circuitry implementing, among others, audio and logic functions of the device 100. For example, the controller 108 may include, but are not limited to, one or more digital signal processor devices, one or more microprocessor devices, one or more processor(s) with accompanying digital signal processor(s), one or more processor(s) without accompanying digital signal processor(s), one or more special-purpose computer chips, one or more field-programmable gate arrays (FPGAs), one or more controllers, one or more application-specific integrated circuits (ASICs), one or more computer(s), various analog to digital converters, digital to analog converters, and/or other support circuits. Control and signal processing functions of the device 100 are allocated between these devices according to their respective capabilities. The controller 108 thus may also include the functionality to convolutionally encode and interleave message and data prior to modulation and transmission. The controller 108 may additionally include an internal voice coder, and may include an internal data modem. Further, the controller 108 may include functionality to operate one or more software programs, which may be stored in a memory. For example, the controller 108 may be capable of operating a connectivity program, such as a conventional Web browser. The connectivity program may then allow the device 100 to transmit and receive Web content, such as location-based content and/or other web page content, according to a Wireless Application Protocol (WAP), Hypertext Transfer Protocol (HTTP) and/or the like. In an example embodiment, the controller 108 may be embodied as a multi-core processor such as a dual or quad core processor. However, any number of processors may be included in the controller 108.

The device 100 may also comprise a user interface including an output device such as a ringer 110, an earphone or speaker 112, a microphone 114, a display 116, and a user input interface, which may be coupled to the controller 108. The user input interface, which allows the device 100 to receive data, may include any of a number of devices allowing the device 100 to receive data, such as a keypad 118, a touch display, a microphone or other input device. In embodiments including the keypad 118, the keypad 118 may include numeric (0-9) and related keys (#, *), and other hard and soft keys used for operating the device 100. Alternatively, the keypad 118 may include a conventional QWERTY keypad arrangement. The keypad 118 may also include various soft keys with associated functions. In addition, or alternatively, the device 100 may include an interface device such as a joystick or other user input interface. The device 100 further includes a battery 120, such as a vibrating battery pack, for powering various circuits that are used to operate the device 100, as well as optionally providing mechanical vibration as a detectable output.

In an example embodiment, the device 100 includes a media capturing element, such as a camera, video and/or audio module, in communication with the controller 108. The media capturing element may be any means for capturing an image, video and/or audio for storage, display or transmission. In an example embodiment in which the media capturing element is a camera module 122, the camera module 122 may include a digital camera capable of forming a digital image file from a captured image. As such, the camera module 122 includes all hardware, such as a lens or other optical component(s), and software necessary for creating a digital image file from a captured image. Alternatively, the camera module 122 may include only the hardware needed to view an image, while a memory device of the device 100 stores instructions for execution by the controller 108 in the form of software to create a digital image file from a captured image. In an example embodiment, the camera module 122 may further include a processing element such as a co-processor, which assists the controller 108 in processing image data and an encoder and/or decoder for compressing and/or decompressing image data. The encoder and/or decoder may encode and/or decode according to a JPEG standard format or another like format. For video, the encoder and/or decoder may employ any of a plurality of standard formats such as, for example, standards associated with H.261, H.262/ MPEG-2, H.263, H.264, H.264/MPEG-4, MPEG-4, and the like. In some cases, the camera module 122 may provide live image data to the display 116. Moreover, in an example embodiment, the display 116 may be located on one side of the device 100 and the camera module 122 may include a lens positioned on the opposite side of the device 100 with respect to the display 116 to enable the camera module 122 to capture images on one side of the device 100 and present a view of such images to the user positioned on the other side of the device 100.

The device 100 may further include a user identity module (UIM) 124. The UIM 124 may be a memory device having a processor built in. The UIM 124 may include, for example, a subscriber identity module (SIM), a universal integrated circuit card (UICC), a universal subscriber identity module (USIM), a removable user identity module (R-UIM), or any other smart card. The UIM 124 typically stores information elements related to a mobile subscriber. In addition to the UIM 124, the device 100 may be equipped with memory. For example, the device 100 may include volatile memory 126, such as volatile Random Access Memory (RAM) including a cache area for the temporary storage of data. The device 100 may also include other non-volatile memory 128, which may be embedded and/or may be removable. The non-volatile memory 128 may additionally or alternatively comprise an electrically erasable programmable read only memory (EEPROM), flash memory, hard drive, or the like. The memories may store any number of pieces of information, and data, used by the device 100 to implement the functions of the device 100.

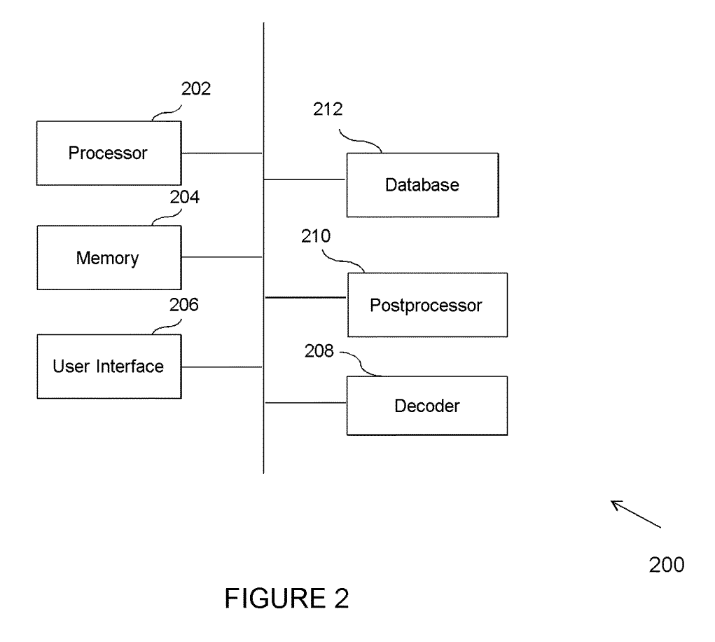

FIG. 2 illustrates an apparatus 200 for summarizing multimedia content in accordance with an example embodiment. The apparatus 200 may be employed, for example, in the device 100 of FIG. 1. However, it should be noted that the apparatus 200, may also be employed on a variety of other devices both mobile and fixed, and therefore, embodiments should not be limited to application on devices such as the device 100 of FIG. 1. In an example embodiment, the apparatus 200 is a low resource embedded device. In an example embodiment, the apparatus 200 is one of a mobile phone and a personal digital assistant (PDA). Alternatively or additionally, embodiments may be employed on a combination of devices including, for example, those listed above. Accordingly, various embodiments may be embodied wholly at a single device, (for example, the device 100 or in a combination of devices). Furthermore, it should be noted that some devices or elements described below may not be mandatory and thus some may be omitted in certain embodiments.

In an example embodiment, the apparatus 200 may summarize the multimedia content. The apparatus 200 includes or otherwise is in communication with at least one processor 202 and at least one memory 204. Examples of the at least one memory 204 include, but are not limited to, volatile and/or non-volatile memories. Some examples of the volatile memory includes, but are not limited to, random access memory, dynamic random access memory, static random access memory, and the like. Some example of the non-volatile memory includes, but are not limited to, hard disks, magnetic tapes, optical disks, programmable read only memory, erasable programmable read only memory, electrically erasable programmable read only memory, flash memory, and the like. The memory 204 may be configured to store information, data, applications, instructions or the like for enabling the apparatus 200 to carry out various functions in accordance with various example embodiments. For example, the memory 204 may be configured to buffer input data for processing by the processor 202. Additionally or alternatively, the memory 204 may be configured to store instructions for execution by the processor 202. In an example embodiment, the memory 204 may be configured to store multimedia content, such as a multimedia file.

The processor 202, which may be an example of the controller 108 of FIG. 1, may be embodied in a number of different ways. The processor 202 may be embodied as a multi-core processor, a single core processor; or combination of multi-core processors and single core processors. For example, the processor 202 may be embodied as one or more of various processing means such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the multi-core processor may be configured to execute instructions stored in the memory 204 or otherwise accessible to the processor 202. Alternatively or additionally, the processor 202 may be configured to execute hard coded functionality. As such, whether configured by hardware or software methods, or by a combination thereof, the processor 202 may represent an entity, for example, physically embodied in circuitry, capable of performing operations according to various embodiments while configured accordingly. Thus, for example, when the processor 202 is embodied as two or more of an ASIC, FPGA or the like, the processor 202 may be specifically configured hardware for conducting the operations described herein. Alternatively, as another example, when the processor 202 is embodied as an executor of software instructions, the instructions may specifically configure the processor 202 to perform the algorithms and/or operations described herein when the instructions are executed. However, in some cases, the processor 202 may be a processor of a specific device, for example, a mobile terminal or network device adapted for employing embodiments by further configuration of the processor 202 by instructions for performing the algorithms and/or operations described herein. The processor 202 may include, among other things, a clock, an arithmetic logic unit (ALU) and logic gates configured to support operation of the processor 202.

A user interface 206 may be in communication with the processor 202. Examples of the user interface 206 include but are not limited to, input interface and/or output user interface. The input interface is configured to receive an indication of a user input. The output user interface provides an audible, visual, mechanical or other output and/or feedback to the user. Examples of the input interface may include, but are not limited to, a keyboard, a mouse, a joystick, a keypad, a touch screen, soft keys, and the like. Examples of the output interface may include, but are not limited to, a display such as light emitting diode display, thin-film transistor (TFT) display, liquid crystal displays, active-matrix organic light-emitting diode (AMOLED) display, a microphone, a speaker, ringers, vibrators, and the like. In an example embodiment, the user interface 206 may include, among other devices or elements, any or all of a speaker, a microphone, a display, and a keyboard, touch screen, or the like. In this regard, for example, the processor 202 may comprise user interface circuitry configured to control at least some functions of one or more elements of the user interface 206, such as, for example, a speaker, ringer, microphone, display, and/or the like. The processor 202 and/or user interface circuitry comprising the processor 202 may be configured to control one or more functions of one or more elements of the user interface 206 through computer program instructions, for example, software and/or firmware, stored on a memory, for example, the at least one memory 204, and/or the like, accessible to the processor 202.

In an example embodiment, the processor 202 is configured to, with the content of the memory 204, and optionally with other components described herein, to cause the apparatus 200 to summarize the multimedia content. The apparatus 200 may receive the multimedia content from internal memory such as hard drive, random access memory (RAM) of the apparatus 200, or from external storage medium such as DVD, Compact Disk (CD), flash drive, memory card, or from external storage locations through the Internet, Bluetooth®, and the like. The apparatus 200 may also receive the multimedia content from the memory 204. An example of multimedia content may be a multimedia file including video data and/or audio data, such as movies, songs, cartoons, animations and camera-captured videos. In an example embodiment, the multimedia file may include a plurality of encoded frames representing audio and video content.

In an example embodiment, the processor 202 operating under software control, or the processor 202 embodied as an ASIC or FPGA specifically configured to perform the operations described herein, or a combination thereof, thereby configures the apparatus or circuitry to select primary summary files for the multimedia content, such as a multimedia file. In an example embodiment, the primary summary files are selected from the encoded frames of the multimedia file.

In an example embodiment, an attribute is calculated for a set of encoded frames. In an example embodiment, the set of encoded frames may comprise predictive frames of the multimedia file. An example of the attribute for the set of encoded frames may be an average frame size of encoded frames included in the set of encoded frames. In an example embodiment, a frame attribute of at least one encoded frame of the set of encoded frames is compared with a threshold value. The threshold value may be based on the attribute for the set of encoded frames. In an example embodiment, the frame attribute of the at least one encoded frame is a frame size of the at least one encoded frame. In an example embodiment, a frame of the set of encoded frames is selected as the primary summary file based on the comparison of the frame attribute of the at least one encoded frame with the threshold value.

In an example embodiment, a plurality of primary summary files is selected from sets of encoded frames representing the multimedia file. For example, once the selection of any primary summary file on a particular set of encoded frames is complete, a subsequent set of encoded frames may be considered for selection of next primary summary file. In an example embodiment, some or all of the sets of encoded frames representing the multimedia file may be considered for the selection of the primary summary files.

The plurality of primary summary files may be displayed to the user for providing contextual summary of the multimedia file to the user. In an example embodiment, each summary file of the plurality of primary summary files is a thumbnail. In an example embodiment, multiple thumbnails are provided to the user to provide a summary of important scenes included in the multimedia file. The user may directly jump to a scene of interest without having to view the entire content of the multimedia file.

In an example embodiment, the processor 202 may utilize a stream parser to parse the frame attribute (for example, a frame size), to parse a frame timestamp and to select encoded frames as primary summary files.

In an example embodiment, the processor 202 is configured to, with the content of the memory 204, and optionally with other components described herein, to cause the apparatus 200 to select the primary summary files in a first pass operation. In an example embodiment, the first pass operation may include calculating an attribute of a set of encoded frames, comparing a frame attribute of at least one encoded frame of the set of encoded frames with the threshold value, and selecting an encoded frame of the set of encoded frames as a primary summary file based on the comparison of the frame attribute of the at least one encoded frame with the threshold value, to be performed on the sets of encoded frames to select the primary summary files.

In an example embodiment, during playback of the multimedia file, the processor 202 is configured to, with the content of the memory 204, and optionally with other components described herein, to cause the apparatus 200 to perform at least one subsequent pass operation on the multimedia file for generating secondary summary files. In an example embodiment, the secondary summary files are generated based on information obtained during the playback of the multimedia file and the primary summary files.

In an example embodiment, the information obtained during the playback of the multimedia file may include, but is not limited to, a color based analysis of individual frames of the multimedia file, quantization parameters of the frames of the multimedia file, motion based visual content variations in each frame of the multimedia file, detected faces in frames, and the like. In an example embodiment, the plurality of secondary summary files may be contextually refined versions of the plurality of primary summary files.

In an example embodiment, the information obtained during the playback of the multimedia file is utilized for performing the least one subsequent pass operation, for example, a raw image based pass operation, a transform domain based pass operation, a motion based pass operation and a facial image based pass operation on the multimedia file. In an example, the at least one subsequent pass operation may include two pass operations. Accordingly, a second pass operation may be one of the raw image based pass operation, the transform domain based pass operation and the motion based pass operation, and, a third pass operation may a facial image based pass operation.

In an example embodiment, the raw image based pass operation, for example, a YUV image based pass operation may be performed by computing for each frame, an average value of luminance component (Y) and two chrominance components (U and V) and, tracking the change in the average value across frames for generating the plurality of secondary summary files. In another example embodiment, the YUV image based pass operation may be performed by using different techniques, such as by utilizing a color region detector or by performing color based analysis of individual frames of the multimedia file.

In an example embodiment, the transform domain based pass operation, for example, a discrete cosine (DC) image based pass operation may be performed by extracting a DC image from frames of the multimedia file. During compression of multimedia content, such as MPEG video, each frame of the video may be divided into 8×8 pixel blocks and the pixels in the blocks may be transformed into 64 coefficients using discrete cosine transform (DCT). The upper leftmost value or the DC term, having 8 times the average intensity of the pixel block, may be extracted and subsequently the average intensity of all blocks in the image may be calculated for forming a reduced version of the original image. This reduced version of original image, or the DC image, provides an indication of the information included in the compressed video. In an example embodiment, the DC image based pass operation may be performed by extracting DC image from the frames, such as the P-frames and the B-frames, of the multimedia file for generating the secondary summary files. In another example embodiment, DC histograms may be utilized for storing information related to features of the frames, and, a difference between the DC histograms may be utilized for performing the DC image based pass operation. In another example embodiment, the DC image based pass operation may be performed by using different techniques related to the DC image in each frame of the multimedia file.

In an example embodiment, the motion based pass operation, for example, motion vector (MV) based pass operation may be performed by a dominant motion estimation procedure and techniques for shot change detection based on motion-induced visual content variations in the frames of the multimedia file. In another example embodiment, the MV based pass operation may be performed by using different techniques, such as slow motion replay detection technique or techniques related to the motion based visual content variations in each frame of the multimedia file.

In an example embodiment, the facial image based pass operation may be performed by utilizing at least one of a face recognition technique, a smile detection technique and a facial feature detection technique. In an example embodiment, the facial image based pass operation may be directed towards identifying scenes including a particular recognizable face, for example, that of a celebrity, and, each of the secondary summary files generated from the facial image based pass operation may be a thumbnail directing a user to a scene including the desired face. In another example embodiment, the facial image based pass operation may be performed by using different techniques related to processing of facial images included in each frame of the multimedia file.

The processor 202 is configured to, with the content of the memory 204, and optionally with other components described herein, to cause the apparatus 200 to perform one or more subsequent pass operations, such as the raw image based pass operation, the transform domain based pass operation, the motion based pass operation and the facial image based pass operation on the multimedia file for generating the plurality of secondary summary files. In an example embodiment, at least one of a transcoding mechanism, an adaptive non-linear sampling, an audio analysis and a pattern recognition technique may be utilized for performing the at least one subsequent pass operation.

In an example embodiment, the processor 202 may be embodied as to include, or otherwise control, a decoder 208. The decoder 208 may be any means such as a device or circuitry operating in accordance with software or otherwise embodied in hardware or a combination of hardware and software. For example, the processor 202 operating under software control, the processor 202 embodied as an ASIC or FPGA specifically configured to perform the operations described herein, or a combination thereof, thereby configures the apparatus or circuitry to perform the corresponding functions of the decoder 208. The decoder 208 decodes the multimedia file received in a compressed (for example, encoded) format for enabling a playback of the multimedia file. The decoder 208 decodes the multimedia file in a format that can be rendered at a display of the user interface 206 for playback. For example, the decoder 208 may convert the multimedia file into a rasterized image, such as a bitmap format, to be rendered at the display for playback. In an example embodiment, the multimedia file is a video file. In an example embodiment, the decoder 208 may convert the video file in a plurality of standard formats such as, for example, standards associated with H.261, H.262/ MPEG-2, H.263, H.264, H.264/MPEG-4, MPEG-4, and the like.

In an example embodiment, the processor 202 may be embodied as, include, or otherwise control, a postprocessor 210. The postprocessor 210 may be any mean such as a device or circuitry operating in accordance with software or otherwise embodied in hardware or a combination of hardware and software. For example, the processor 202 operating under software control, the processor 202 embodied as an ASIC or FPGA specifically configured to perform the operations described herein, or a combination thereof, thereby configures the apparatus or circuitry to perform the corresponding functions of the postprocessor 210. In an example embodiment, the postprocessor 210 updates the primary summary files to the secondary summary files based on information obtained during decoding of the multimedia file from the decoder 208. In an example embodiment, based on the information, each of the primary summary files may be updated to a secondary summary file for generating the secondary summary files. In an example embodiment, based on the information, any number of secondary summary files may be generated regardless of the number of primary summary files.

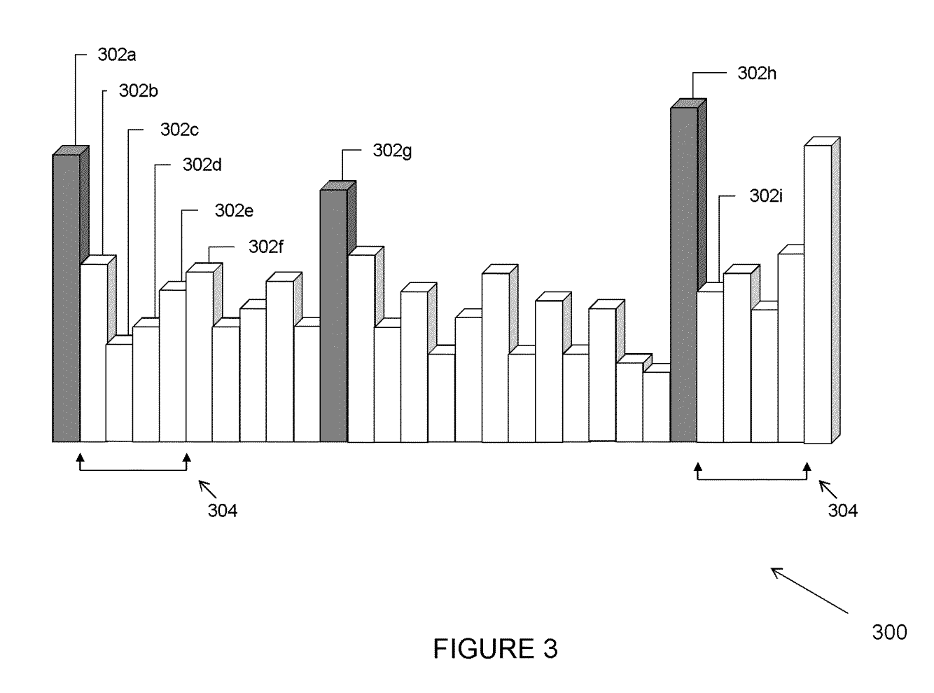

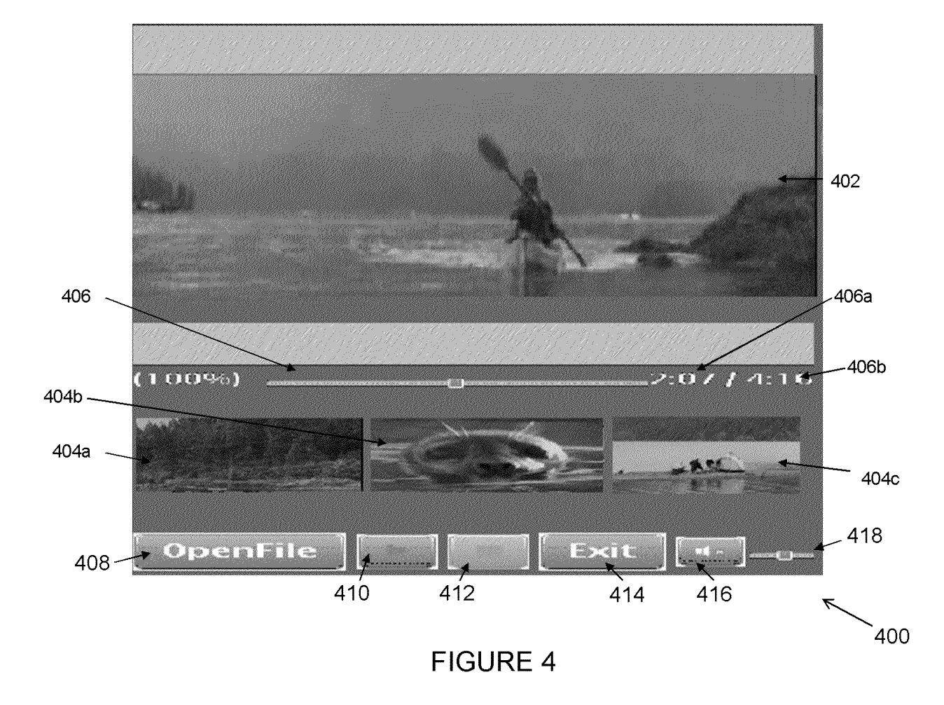

In an example embodiment, the processor 202 may be embodied as to include, or otherwise control, a database 212. The database 212 may be any mean such as a device or circuitry operating in accordance with software or otherwise embodied in hardware or a combination of hardware and software. For example, the processor 202 operating under software control, the processor 202 embodied as an ASIC or FPGA specifically configured to perform the operations described herein, or a combination thereof, thereby configures the apparatus or circuitry to perform the corresponding functions of the database 212. In an example embodiment, the database 212 stores the primary summary files. In an example embodiment, the secondary summary files may also be stored in the database 212. In an example embodiment, the database 212 may be configured to store logic to perform the first pass operation and subsequent pass operations, such as a second pass operation or a third pass operation. An example of the first pass operation for generating the plurality of primary summary files is described in FIG. 3. An example of a display depicting the primary summary files is shown in FIG. 4.

FIG. 3 illustrates example encoded frames 300 of a multimedia file, in accordance with an example embodiment. The example encoded frames 300 include frames, such as a frame 302a, a frame 302b, a frame 302c, a frame 302d, a frame 302e and a frame 302f. The encoded frames 300 may include intra-frames (I-frames) and predictive frames (P-frames). For example, in FIG. 3, the frame 302a is I-frame and the frames 302b, 302c, 302d, 302e and 302f are P-frames. In an example embodiment, a set of encoded frames includes predictive frames of the multimedia file.

In an example embodiment, an attribute for the set of encoded frames, for example the frames 302b, 302c, 302d and 302e, may be calculated. In an example embodiment, the attribute for the set of encoded frames 302b, 302c, 302d and 302e may be calculated by overlaying a detection window on the frames 302b, 302c, 302d and 302e. For example, as shown in FIG. 3, an example detection window 304 is overlaid on the frames 302b, 302c, 302d and 302e for calculating an attribute for these set of encoded frames. In an example embodiment, the detection window 304 may be considered as boundary-outline capable of being overlaid over a portion of the encoded frames of multimedia file and calculating an attribute for features encompassed in the portion of the encoded frames of the multimedia file. An example of an attribute of the set of encoded frames is an average frame size (B_{W}) or a number of bits per frame.

In an example embodiment, a size (W) of the detection window 304 may be defined by a predetermined maximum number (M) of primary summary files and a time-duration (L) associated with the multimedia file. In an example embodiment, the size (W) of the detection window 304 may be defined as round mathematical operator of L and M as below:

W=round (L/M)

In an example embodiment, the predetermined maximum number (M) of primary summary files may be based on a user input. In another example embodiment, the predetermined maximum number of primary summary files may be pre-defined by the processor 202.

In an example embodiment, a frame attribute of at least one encoded frame of the set of encoded frames may be compared with a threshold value. The threshold value may be based on the attribute for the set of encoded frames. In an example embodiment, the frame attribute of the at least one encoded frame may be a frame size of the at least one encoded frame. In an example embodiment, a frame of the set of encoded frames may be selected as a primary summary file based on a comparison of the frame attribute of the at least one encoded frame with the threshold value.

For example, in FIG. 3, the detection window 304 is overlaid on the set of encoded frames including frames 302b, 302c, 302d and 302e. The attribute for the set of encoded frames, for example, an average frame size for frames 302b, 302c, 302d and 302e is calculated. A frame attribute of at least one encoded frame, such as frame 302b, is compared with the threshold value. It is determined whether the frame 302b can be selected as a primary summary file or not, based on the comparison between the frame size of the frame and the threshold value. In an example embodiment, a frame size of each frame (frames 302b, 302c, 302d and 302e) is compared with the threshold value. In an example embodiment, the threshold value is the attribute of the set of encoded frames multiplied by a heuristic factor (K). For example, the threshold value may be B_{W}*K. If a frame attribute (F_{N}), such as the frame size, of a particular frame deviates from the threshold value, then the frame is determined as a primary summary file. For F_{N} to be marked as a primary summary file,

$${F}_{N} > K * {B}_{W}$$

$$or {F}_{N} < ( {B}_{W} / 2 * K )$$

$$where {B}_{W} = ( 1 / ( N - 1 ) ) * {\sum }_{i = 0}^{i = N - 1} Fi ,$$

N is the total number of frames in the set of encoded frames. Examples of values of heuristic factor K may be 1.5 or 0.75. Accordingly, if the frame size of an encoded frame in the set of encoded frames exceeds 1.5 times the average frame size of the encoded frames overlaid within the detection window or is lower than 0.75 times the average frame size of the encoded frames overlaid within the detection window, then the encoded frame may be selected as a primary summary file. In other examples, the heuristic factor K may also assume any other value.

In an example embodiment, a step size for traversing the detection window 304 may be a predefined number of encoded frames of the multimedia file. In an example embodiment, the step size for traversing the detection window 304 is one encoded frame of the multimedia file. The detection window 304 may accordingly traverse to a subsequent set of encoded frames including frames 302c, 302d, 302e and 302f. The detection window 304 may be traversed to a plurality of set of encoded frames such as the set of encoded frames including frames 302b, 302c, 302d and 302e, and frames overlaid within each set of encoded frames may be evaluated for determining primary summary files. The plurality of primary summary files representing the multimedia file may be generated in this manner. In FIG. 3, frame 302g depicts an example of a frame selected as a primary summary file by traversing the detection window 304 over sets of frames of the plurality of set of encoded frames

In an example embodiment, the detection window 304 may be traversed to a subsequent frame of an encoded frame selected as a primary summary file upon selection of the frame as the primary summary file. For example, upon selection of a frame 302h as a primary summary file, the detection window 304 may be traversed to a set of encoded frames beginning from frame 302i for performing evaluation of frames for determining the plurality of primary summary files. The selection of the primary summary file based on the deviation from the threshold value may be indicative of a key-frame (I-frame) and hence a beginning of a new shot in a multimedia file. Therefore, the evaluation may be performed on the P-frames as the P-frames maintain continuity, for detection of next primary summary file.

In an example embodiment, traversing of the detection window 304 may be chosen in a manner such that the processing for generating a plurality of primary summary files need not be performed on all encoded frames of the multimedia file. For example, encoded frames at even intervals (M) of the multimedia file may be evaluated for generating primary summary files. For example, instead of traversing the detection window 304 from the set of encoded frames including frames 302b, 302c, 302d and 302e to the set of encoded frames including frames 302c, 302d, 302e and 302f (step size of 1), the detection window may be traversed to a set of encoded frames beginning from frame 302e, thereby skipping frames 302c and 302d (step size of 3). At each set of encoded frames, an attribute for the set of encoded frames may be calculated, and, a frame attribute of at least one encoded frame in the set of encoded frames compared with the threshold value. For F_{N} to be marked as a primary summary file,

$${F}_{N} > K * {B}_{W}$$

$$or , {F}_{N} < ( {B}_{W} / 2 * K )$$

$$where , {B}_{W} = ( M / ( N - 1 ) ) * {\sum }_{i = 0}^{i = N - 1} Fi * M$$

In another example embodiment, only a few frames in the set of encoded frames overlaid within the detection window may be evaluated for selection as a primary summary file. For example, frame attributes of only even frames (for example, frames 302c and 302e) or odd frames (for example, frames 302b and 302d) in the set of encoded frames (for example, frames 302b, 302c, 302d and 302e) overlaid within the detection window may be compared with the threshold value for the selection of the at least one encoded frame as a primary summary file.

In an example embodiment, each primary summary file is a thumbnail. In an example embodiment, the plurality of primary summary files in form of thumbnails is displayed along with the multimedia file representation for providing a contextual summary of content included within the multimedia file to a user. An exemplary display depicting a plurality of primary summary files along with the multimedia file representation is illustrated in FIG. 4.

FIG. 4 illustrates an example of a display 400 depicting plurality of primary summary files in accordance with an example embodiment. The display 400 depicts a screenshot 402 of an instance captured during playback of the multimedia file along with the plurality of primary summary files, such as a primary summary file 404a, a primary summary file 404b and a primary summary file 404c. The primary summary files 404a, 404b and 404c are depicted as thumbnails. The plurality of primary summary files represents the multimedia file associated with the screenshot 402. In the example embodiment depicted in FIG. 3, three primary summary files 404a, 404b and 404c are shown, however, any number of primary summary files may be generated for representing the multimedia file.

As explained in FIG. 2 and FIG. 3, the processor 202 may be configured to perform a first pass operation on a multimedia file for generating a plurality of primary summary files. The plurality of primary summary files is displayed to provide a contextual summary of the multimedia file. Providing the contextual summary of the multimedia file may be useful as it precludes the need to view the entire content of the multimedia file to seek to a scene of interest. The primary summary files of the plurality of primary summary files may be clicked to jump to the scene of interest.

Clicking on a thumbnail, such as the primary summary file 404a, may provide a playback of the multimedia file from a scene depicted in the thumbnail. In FIG. 4, a screenshot of the playback is depicted in form of the screenshot 402. A seek-bar 406 is depicted along with the screenshot 402, which provides an indication of a timing reference 406a of a current playback scene as well as an indication of total time duration 406b of the entire length of the multimedia file. In FIG. 4, the total time duration 406b of the multimedia file is depicted as “4:16”, implying four minutes and sixteen seconds time duration, and the timing reference 406a of a current playback scene is depicted as “2:07”, implying that current playback scene's timing reference in the multimedia file is at two minutes and seven seconds of the total time duration of “4:16”. Additionally, the screenshot 402 may depict icons such as “open file” 408, “Play” 410, “Stop” 412, “Exit” 414, “Volume mute control” 416, and “volume seek bar” 418 for opening the multimedia file, initiating playback of the multimedia file, stopping the playback of the multimedia file, exiting the multimedia file, controlling an on/off operation of an audio component of the multimedia file and increasing/decreasing the audio component, respectively.

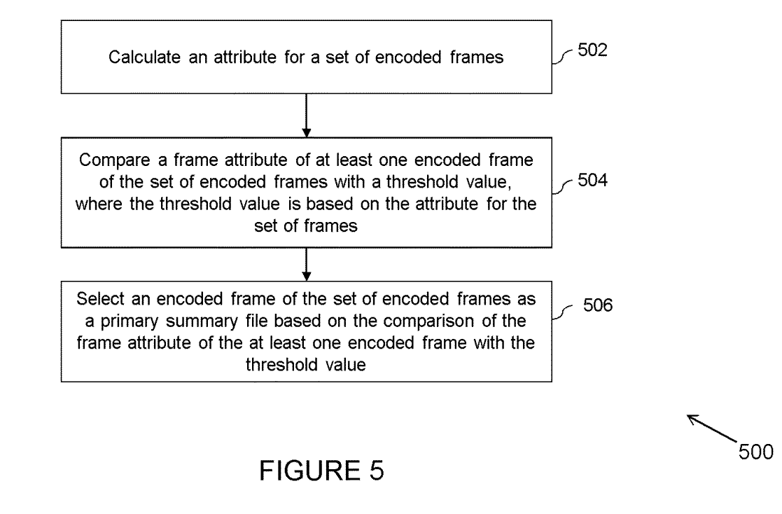

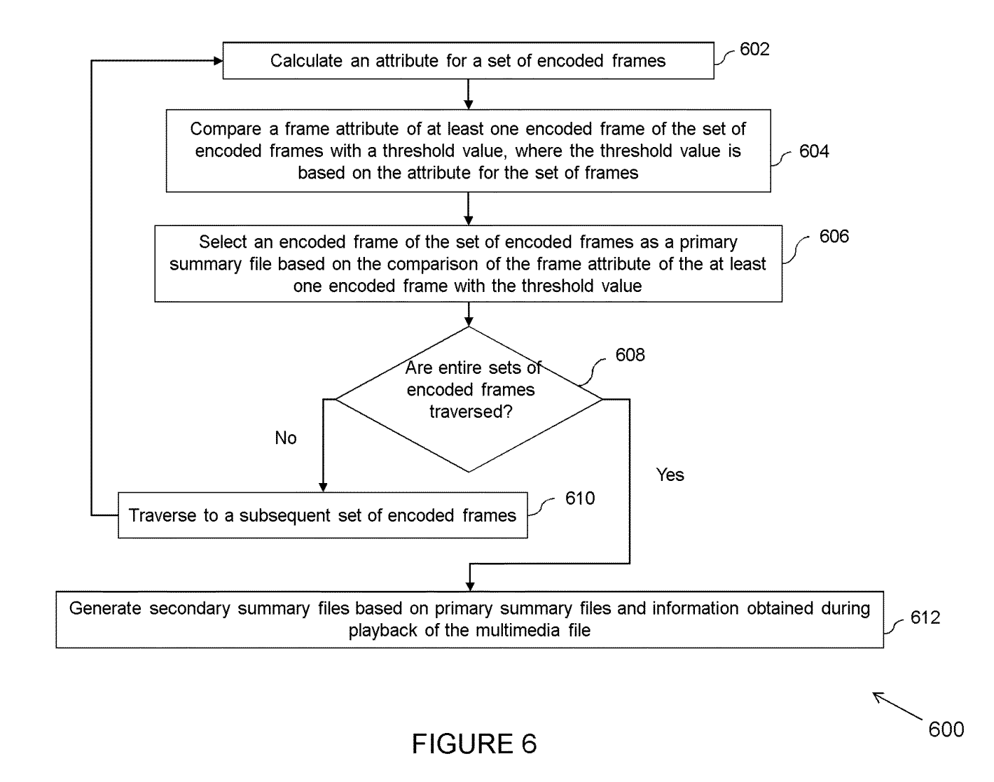

In an example embodiment, the processor 202 may perform the first pass operation upon detection of loading of a multimedia file to the memory 204 to generate the primary summary files. In an example embodiment, the primary summary files may be considered to be providing a coarse contextual summary of the multimedia file as they are generated based on attributes such as number of bits per frame (frame size) and prior to decoding of the multimedia file. In an example embodiment, the primary summary files providing the coarse contextual summary are displayed to the user for seeking to scene of interest without viewing of the entire content of the multimedia file, thereby enhancing a user experience. During decoding of the multimedia file by decoder 208 for playback, information such as a color information, a motion related information, quantization parameters (QP) related information, and information related to image features, such as presence of a face, may be obtained. Based on such information, the processor 202 may perform at least one subsequent pass operation on the multimedia file. In an example embodiment, the at least one subsequent pass operation may be a raw image based pass operation, a transform domain based pass operation, a motion based pass operation and/or a facial image based pass operation. The at least one subsequent pass operation may be performed for refining the primary summary files and updating to the secondary summary files, which may be stored in the database 216. The secondary summary files may be displayed on subsequent retrieval of the multimedia file. A method for summarizing of multimedia content is explained in FIGS. 5 and 6.

FIG. 5 is a flowchart depicting an example method 500 for summarizing multimedia content in accordance with an example embodiment. In an example embodiment, the multimedia content is a multimedia file, for example, a video file. The method 500 depicted in the flow chart may be executed by an apparatus, for example, the apparatus 200 of FIG. 2. In an example embodiment, the apparatus is a low resource embedded device. In an example embodiment, the low resource embedded device is one of a mobile phone and a personal digital assistant (PDA).

At block 502, an attribute for a set of encoded frames is calculated. An example of the attribute for the set of encoded frames may be an average frame size of the frames included in the set of encoded frames.

At block 504, a frame attribute of at least one encoded frame of the set of encoded frames is compared with a threshold value. The threshold value is based on the attribute for the set of encoded frames. An example of the frame attribute may be a frame size of the at least one encoded frame. At block 506, a frame of the set of encoded frames is selected as a primary summary file based on the comparison of the frame attribute of the at least one encoded frame with the threshold value. In an example embodiment, multiple primary summary files may be selected by traversing the detection window over a plurality of set of encoded frames, and performing calculating, comparing and selecting the primary summary files on these sets of encoded frames. In an example embodiment, the primary summary files representing the multimedia file may be displayed, for example, by the user interface 206. The plurality of primary summary files may be displayed as shown in FIG. 4.

FIG. 6 is a flowchart depicting an example method 600 for summarizing multimedia content in accordance with another example embodiment. The method 600 depicted in flow chart may be executed by, for example, the apparatus 200 of FIG. 2. Operations of the flowchart, and combinations of operation in the flowchart, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions, which embody the procedures, described in various embodiments may be stored by at least one memory device of an apparatus and executed by at least one processor in the apparatus. Any such computer program instructions may be loaded onto a computer or other programmable apparatus (for example, hardware) to produce a machine, such that the resulting computer or other programmable apparatus embody means for implementing the operations specified in the flowchart. These computer program instructions may also be stored in a computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the operations specified in the flowchart. The computer program instructions may also be loaded onto a computer or other programmable apparatus to cause a series of operations to be performed on the computer or other programmable apparatus to produce a computer-implemented process such that the instructions, which execute on the computer or other programmable apparatus provide operations for implementing the operations in the flowchart. The operations of the method 600 are described with help of apparatus 200. However, the operations of the method 600 can be described and/or practiced by using any other apparatus.

The multimedia content, such as a multimedia file may be loaded to a memory, such as the memory 204, on account of capture of multimedia information by a user or transfer of a multimedia file from an external memory device, such as a universal serial bus (USB). At block 602, on detecting a loading of the multimedia file, an attribute for a set of encoded frames of the multimedia file is calculated. In an example embodiment, a detection window may be overlaid over the set of encoded frames, and the attribute for the set of encoded frames within the detection window is calculated. An example of the attribute of the set of encoded frames may be an average frame size of the frames included in the set of encoded frames.

At block 604, a frame attribute of at least one encoded frame of the set of encoded frames is compared with a threshold value. In an example embodiment, the threshold value is based on the attribute for the set of encoded frames. An example of the frame attribute may be a frame size of the at least one encoded frame. At block 606, a frame of the set of encoded frames is selected as a primary summary file based on the comparison of the frame attribute of the at least one encoded frame with the threshold value. The detection window may be similar to the detection window 304.

At block 608, it is determined whether the entire sets of encoded frames are traversed. If it is determined that the entire sets of encoded frames are not traversed, the detection window is traversed to a subsequent set of encoded frames at block 610. Accordingly the steps of blocks 602, 604 and 606 are performed on the subsequent set of encoded frames. In an example embodiment, a plurality of primary summary files may be selected on traversing the entire sets of encoded frames. In an example embodiment, the plurality of primary summary files may be enabled, for example by the user interface 206, for display. In an example embodiment, each primary summary file of the plurality of primary summary files is a thumbnail. The plurality of primary summary files, in form of thumbnails, may be displayed to the user as shown in FIG. 4.

If it is determined that the entire sets of encoded frames are traversed, at block 612, secondary summary files may be generated based on the primary summary files and information obtained during the playback of the multimedia file. The playback of the multimedia file may involve decoding of the multimedia file which may generate information, which may include, but is not limited to, a color based analysis of individual frames of the multimedia file, quantization parameters of the frames of the multimedia file, motion based visual content variations in each frame of the multimedia file, detected faces in frames, and the like. In an example embodiment, the plurality of secondary summary files may be contextually refined versions of the plurality of primary summary files. In an example embodiment, the information obtained during playback of the multimedia file may be utilized for performing the least one subsequent pass operation, for example, a raw image based pass operation, a transform domain based pass operation, a motion based pass operation and a facial image based pass operation. The at least one subsequent pass operation on the multimedia file generates the secondary summary files based on the primary summary files and information obtained during the playback of the multimedia file. As explained in FIGS. 3 and 4, the secondary summary files provide refined contextual summary of the content included in the multimedia file.

Without in any way limiting the scope, interpretation, or application of the claims appearing below, a technical effect of one or more of the example embodiments disclosed herein is to summarize of multimedia content, for example a multimedia file. Upon detection of loading of the multimedia file, a first pass operation may be performed on the multimedia file to generate a plurality of primary summary files, for example in form of thumbnails, representing the multimedia file. The plurality of primary summary files provide a coarse contextual summary thereby enhancing a see-seek operation. The plurality of primary summary files may be utilized for jumping to a scene of interest without having to view the entire content for identifying the scene of interest. Further, the plurality of primary summary files are generated without any need of partial or full decoding of the multimedia content, thereby saving time and enhancing a user experience. For low resource embedded devices, like mobile phones and PDAs, with limited processing power, the first pass operation makes generation of multiple thumbnails feasible with low latency thereby greatly enhancing user experience. A battery life of such devices may also be improved on account of reduced processing power usage of the devices in summarizing the multimedia content.

During playback, a partial or full decoding of the multimedia content is performed. Without any extra computations, the information obtained during the decoding process may be utilized to perform subsequent pass operations to refine the coarse contextual summary provided by the plurality of primary summary files to a plurality of secondary summary files providing refined contextual summary. Such a multi-pass operation performed on the multimedia file enhances a user experience by providing a contextual summary of the multimedia file while reducing complexity especially for low resource embedded devices. Moreover, the multi-pass operation may be performed by using existing components in the low resource embedded devices for decoding and parsing and hence can support all video formats initially supported by the devices. The multi-pass operation may be feasible for all types of videos camera captured, cartoons, movies, songs etc—as the subsequent pass operations may be tuned without affecting user experience.

Various embodiments described above may be implemented in software, hardware, application logic or a combination of software, hardware and application logic. The software, application logic and/or hardware may reside on at least one memory, at least one processor, an apparatus or, a computer program product. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of an apparatus described and depicted in FIGS. 1 and/or 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present disclosure as defined in the appended claims.

We claim:

1. A method comprising:
calculating an attribute for a set of encoded frames of a multimedia file;
comparing a frame attribute of at least one encoded frame of the set of encoded frames with a threshold value, wherein the threshold value is based on the attribute for the set of encoded frames; and
selecting an encoded frame from the set of encoded frames as a primary summary file of the multimedia file based on the comparison of the frame attribute of the at least one encoded frame with the threshold value.

2. The method of claim 1 further comprising calculating, comparing and selecting on a subsequent set of encoded frames.

3. The method of claim 2 further comprising generating secondary summary files based on primary summary files and information obtained during playback of the multimedia file.

4. The method of claim 3, wherein the information is obtained based on at least one of a raw image based pass operation, a transform domain based pass operation, a motion based pass operation and a facial image based pass operation.

5. The method of claim 1, wherein the set of encoded frames comprises predictive frames of the multimedia file.

6. The method of claim 1, wherein the attribute for the set of encoded frames is an average frame size of frames included in the set of encoded frames.

7. The method of claim 1, wherein the frame attribute of the at least one encoded frame is a frame size of the at least one encoded frame.

8. An apparatus comprising:
at least one processor; and
at least one memory comprising computer program code, the at least one memory and the computer program code configured to, with the at least one processor, cause the apparatus at least to:
calculate an attribute for a set of encoded frames of a multimedia file;
compare a frame attribute of at least one encoded frame of the set of encoded frames with a threshold value, wherein the threshold value is based on the attribute for the set of encoded frames; and
select an encoded frame of the set of encoded frames as a primary summary file of the multimedia file based on the comparison of the frame attribute of the at least one encoded frame with the threshold value.

9. The apparatus of claim 8, wherein the apparatus is further caused, at least in part, to perform the following: calculate, compare and select on a subsequent set of encoded frames.

10. The apparatus of claim 9, wherein the apparatus is further caused, at least in part, to generate secondary summary files based on primary summary files and information obtained during playback of the multimedia file.

11. The apparatus of claim 10, wherein the information is obtained based on at least one of a raw image based pass operation, a transform domain based pass operation, a motion based pass operation and a facial image based pass operation.

12. The apparatus of claim 10, wherein the apparatus is further caused, at least in part, to display at least one of the primary summary files and the secondary summary files.

13. The apparatus of claim 10, wherein the primary summary files and the secondary summary files comprise thumbnails.

14. The apparatus of claim 8, wherein the set of encoded frames comprises predictive frames of the multimedia file.

15. The apparatus of claim 8, wherein the attribute for the set of encoded frames is an average frame size of frames included in the set of encoded frames.

16. The apparatus of claim 8, wherein the frame attribute of the at least one encoded frame is a frame size of the at least one encoded frame.

17. The apparatus of claim 8, wherein the multimedia file is a video file.

18. A computer program product comprising at least one computer-readable storage medium, the computer-readable storage medium comprising a set of instructions, which, when executed by one or more processors, cause an apparatus to at least:
calculate an attribute for a set of encoded frames of a multimedia file;
compare a frame attribute of at least one encoded frame of the set of encoded frames with a threshold value, wherein the threshold value is based on the attribute for the set of encoded frames; and
select an encoded frame of the set of encoded frames as a primary summary file of the multimedia file based on the comparison of the frame attribute of the at least one encoded frame with the threshold value.

19. The computer program product of claim 18, wherein the apparatus is further caused, at least in part, to perform the following calculate, compare and select on a subsequent set of encoded frames.

20. The computer program product of claim 19, wherein the apparatus is further caused, at least in part, to generate secondary summary files based on primary summary files and information obtained during playback of the multimedia file.

21. The computer program product of claim 20, wherein the information is obtained based on at least one of a raw image based pass operation, a transform domain based pass operation, a motion based pass operation and a facial image based pass operation.
